(19) United States
(12) Patent Application Publication
(10) Pub. No.: US 2019/0197481 A1
(43) Pub. Date: Jun. 27, 2019

(54) USER INTERFACE FOR COMPARABLE RECRUITER INFORMATION

(71) Applicants: Ping Zhu, Sunnyvale, CA (US); Lin Yang, San Carlos, CA (US); Peter Hume Rigano, San Francisco, CA (US)

(72) Inventors: Ping Zhu, Sunnyvale, CA (US); Lin Yang, San Carlos, CA (US); Peter Hume Rigano, San Francisco, CA (US)

(21) Appl. No.: 15/852,834

(22) Filed: Dec. 22, 2017

(51) Int. Cl. G06Q 10/10; G06Q 50/00; G06F 17/30

(52) U.S. Cl. CPC G06Q 10/1053; G06F 17/30867; G06Q 50/01

(57) ABSTRACT

A system and method includes obtaining, for a population of users of an online networking system having a common profession, data related to factors pertaining to the profession from a database of the online networking system and successively, for each of the factors individually, removing from the population of users those whose data relating to the factor is not similar to related data of a subject user until a quantity of the population of users is within a predetermined range to obtain a comparable population of users that have similar data to the subject user. A statistic is compared from the data of the subject user against the same statistic from the data of each of the users of the comparable population of users to obtain a comparison. The user interface displays the statistic and information related to the comparison.

### TECHNICAL FIELD

The subject matter disclosed herein generally relates to a user interface for comparable recruiter information.

### BACKGROUND

Certain of an online networking system may utilize electronic communications within the system to attempt to contact members of the system. Recruiters for a variety of purposes, including job recruiters, may utilize online networking systems to identify candidates for a position. Conventionally, recruiters may scan through network profiles and compile a list of prospects. The recruiters may then contact some or all of the candidates with information about the position using one of several communications media. Candidates who reply to the communication may then enter a normal recruitment process, such as with live meetings and interviews.

### BRIEF DESCRIPTION OF THE DRAWINGS

Some embodiments are illustrated by way of example and not limitation in the figures of the accompanying drawings.

FIG. 1 is a block diagram illustrating various components or functional modules of an online social networking system, consistent with some examples.

FIG. 2 is a simplified depiction of a user interface as provided by an social networking system, in an example embodiment.

FIG. 3 is a simplified diagram of a recruiter population as factors are successively, individually applied from a factors list to the population to obtain a comparable recruiter population, in an example embodiment.

FIG. 4 is a flowchart for successively applying factors to a recruiter population to obtain a comparable recruiter population, in an example embodiment.

FIG. 5 is a flowchart for applying generating a user interface for comparable recruiter information, in an example embodiment.

FIG. 6 is a block diagram illustrating components of a machine able to read instructions from a machine-readable medium.

### DETAILED DESCRIPTION

Example methods and systems are directed to a user interface for comparable recruiter information. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

User interfaces may present recruiters with statistics and other analytics related the rate at which they receive responses to electronic communications. Recruiters may judge the success of their efforts based on their own rate, particularly in comparison to that of other recruiters. However, not all recruiters are at equal or similar advantages or disadvantages. The expected rate at which a recruiter receive responses may vary significantly dependent on the recruiter's own role or job, the contracts and incentives the recruiter is operating under, the size of the recruiter's employer, an industry in which the recruiter is recruiting, the seniority of the candidates the recruiter is seeking, the position that is being recruited for, the size of the employer being recruited for, and the industry of the employer. Senior recruiters seeking candidates from relatively small companies in comparatively unpopular industries for jobs at large, high profile companies in competitive industries may expect a much higher response rate than recruiters seeking relatively more difficult candidates or recruiting for relatively more undesirable positions.

However, simply combining all known factors that may tend to influence the likely success rate of a recruiter may produce an undesirably specific profile of the recruiter for the purposes of comparison with other recruiters. An analysis that relies on too small of a population may result in statistical outliers. As such, it is desirable to utilize a sample size that is neither too large nor too small.

An enhanced user interface has been developed that provides for analytics for a recruiter or other professional in a role related to activities on an online social networking system or other online environment. The user interface displays the analytics based on a iteratively or successively applying factors related to how the professional compares to other professionals in the same role until a population of other professionals reaches a size that is within a specified range having both an upper and a lower bound. The user interface may also provide for user interaction to select the factors that are utilized in deciding the population of professionals.

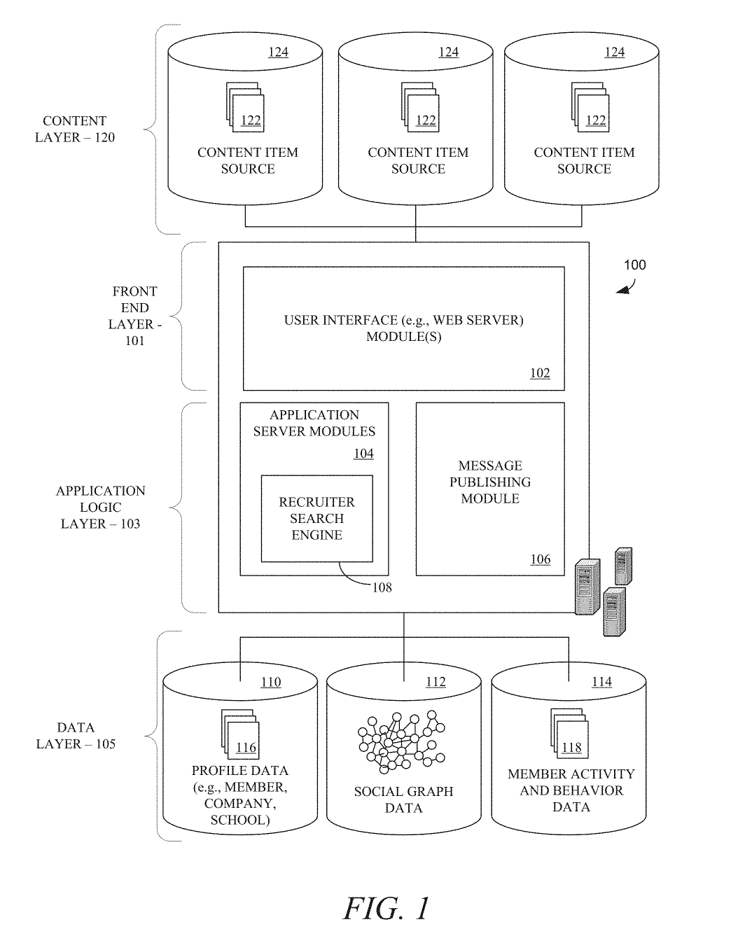

FIG. 1 is a block diagram illustrating various components or functional modules of an online social networking system 100, consistent with some examples. A front end 101 consists of a user interface module (e.g., a web server) 102, which receives requests from various client-computing devices, and communicates appropriate responses to the requesting client devices. For example, the user interface module(s) 102 may receive requests in the form of Hypertext Transport Protocol (HTTP) requests, or other web-based, application programming interface (API) requests. An application logic layer 103 includes various application server modules 104, which, in conjunction with the user interface module(s) 102, may generate various user interfaces (e.g., web pages, applications, etc.) with data retrieved from various data sources in a data layer 105. In some examples, individual application server modules 104 may be used to implement the functionality associated with various services and features of the social network service. For instance, the ability of an organization to establish a presence in the social graph of the social network system 100, including the ability to establish a customized web page on behalf of an organization, and to publish messages or status updates on behalf of an organization, may be services implemented in independent application server modules 104. Similarly, a variety of other applications or services that are made available to members of the social network service may be embodied in their own application server modules 104.

Alternatively, various applications may be embodied in a single application server module 104. In some examples, the social network system 100 includes a content item publishing module 106, such as may be utilized to receive content, such as electronic messages, posts, links, images, videos, and the like, and publish the content to the social network.

One or more of the application server modules 104, the content item publishing module 106, or the social network system 100 generally may include a recruiter search engine 108. As will be disclosed in detail herein, the recruiter search engine 108 may access information from the data layer 105 in relation to specified factors pertaining to a population of recruiters and narrow the population of recruiters down to a population range having both an upper and a lower bound. It is noted that while recruiters are described specifically, the principles disclosed herein are applicable to any professional type that engages in activities in the online social networking system 100 that may be stored in the data layer 105.

The recruiter search engine 108 may be implemented on a separate server or may be part of a server that provides other portions of the social network system 100. Thus, it is to be understood that while the recruiter search engine 108 is described as an integral component of the online social networking system 100, the principles described herein may be applied without the recruiter search engine 108 being an integral part of the online social networking system or even necessarily utilizing data from a social network if information that would normally be stored in the data layer 105 is available from alternative sources.

As illustrated, the data layer 105 includes, but is not necessarily limited to, several databases 110, 112, 114, such as a database 110 for storing profile data 116, including both member profile data as well as profile data for various organizations. Consistent with some examples, when a person initially registers to become a member of the social network service, the person may be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 110. Similarly, when a representative of an organization initially registers the organization with the social network service, the representative may be prompted to provide certain information about the organization. This information may be stored, for example, in the database 110, or another database (not shown). With some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company. With some examples, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some examples, a member may elect to “follow” another member. In contrast to establishing a connection, the concept of “following” another member typically is a unilateral operation, and at least with some examples, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph database 112.

Activities by users of the social network system 100, including past interactions that have resulted from prior searches conducted by the recruiter search engine 108, may be logged as activities 118 in the activity and behavior database 114. Such activities may include search terms, interactions with search results by recruiters, and subsequent engagement between the recruiter and the candidate members who were produced by searches, and so forth. Profile data 116, activities 118, and the social graph of a member may collectively be considered characteristics of the member and may be utilized separately or collectively as disclosed herein.

The data layer 105 collectively may be considered a content item database, in that content items, including but not limited to member profiles 116, may be stored therein. Additionally or alternatively, a content item layer 120 may exist in addition to the data layer 105 or may include the data layer 105. The content item layer 120 may include individual content items 122 stored on individual content item sources 124. The member profiles 116 and the activities 118 may be understood to be content items 122, while the profile database 110, the social graph database 112, and the member activity database 114 may also be understood to be content item sources 124. Content items 122 may further include sponsored content items as well as posts to a news feed, articles or links to websites, images, sounds, event notifications and reminders, recommendations to users of the social network for jobs or entities to follow within the social network, and so forth.

The social network system 100 may provide a broad range of other applications and services that allow members the opportunity to share and receive information, often customized to the interests of the member. For example, the social network service may include a photo sharing application that allows members to upload and share photos with other members. In some examples, members may be able to self-organize into groups, or interest groups, organized around a subject matter or topic of interest. In some examples, the social network service may host various job listings providing details of job openings with various organizations.

Although not shown, with some examples, the social network system 100 provides an application programming interface (API) module via which third-party applications can access various services and data provided by the social network service. For example, using an API, a third-party application may provide a user interface and logic that enables an authorized representative of an organization to publish messages from a third-party application to various content streams maintained by the social network service. Such third-party applications may be browser-based applications, or may be operating system-specific. In particular, some third-party applications may reside and execute on one or more mobile devices (e.g., phone, or tablet computing devices) having a mobile operating system.

Conventionally, a recruiter inputs into the online social networking system 100 a job with associated parameters or characteristics that a candidate would at minimum need to meet to be considered for the position. The online social networking system 100 then cross-references the characteristics of the job with member data of members of the online social networking system 100 stored in the data layer 105 to output a list of members who meet the minimum requirements for the job. The list may be ordered based on which members are best qualified for the job or may not be ordered. The recruiter may then review the list and select members to receive an electronic communication through the online social networking system 100 regarding the job from the recruiter. The members who receive the electronic communication may either decline to respond to the recruiter or may response with their own electronic message acknowledging receipt of the electronic message from the recruiter. The recruiter may then follow up with the member to further advance the consideration of the candidate/member for consideration for the job, e.g., with an interview, a further request for information, etc.

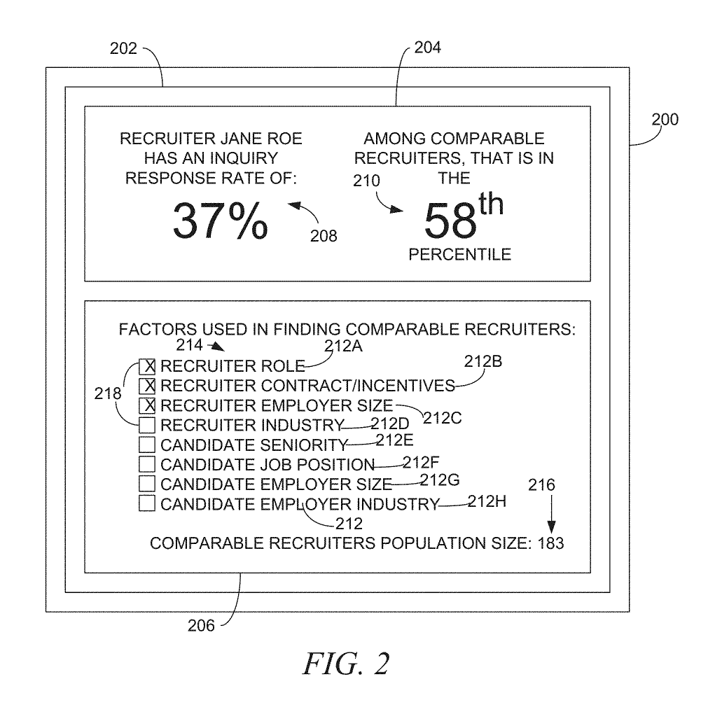

FIG. 2 is a simplified depiction of a user interface 200 as provided by the social networking system 100, in an example embodiment. The user interface 200 may be displayed on a user device, such as a personal computer, tablet computer, smartphone, and the like. The user interface 200 includes a recruiter analytics window 202 including a results window 204 and a recruiter population window 206. The results window 204 displays information regarding how a subject recruiter compares to other similar recruiters. The recruiter population window 206 displays information about the population of other recruiters the subject recruiter was compared to and the provision for the user to adjust the population of other recruiters the subject recruiter was compared against.

The results window 204 includes a response rate statistic 208 and a comparable recruiter ranking 210. The response rate statistic 208 is presented without respect to the performance of any other recruiter and is simply related to the performance of the subject recruiter. The response rate statistic presented is the percentage of candidates who respond to an electronic inquiry from the subject recruiter, in this illustrative case named Jane Roe. In an example, the response rate is related to all of the responses from candidates for the subject recruiter over a predetermined period of time, e.g., the last three months. In various examples, the response rate may be selectively applied to specific positions the recruiter is searching for or otherwise customized for specific analytical purposes. While the user interface 200 is simplified to illustrate particular functions, it is to be recognized and understood that the user interface 200 may include additional windows or the illustrated windows 204, 206 may be modified to allow for the customization of analytical information presented. Moreover, while the results window is discussed with respect to the response rate statistic 208, it is to be recognized and understood that any statistic or analytical framework may be displayed instead of or in addition to the response rate statistic 208.

The comparable recruiter ranking 210 statistic is based on the response rate statistic 208 in comparison to the recruiters in the larger population of recruiters on the online social networking system 100. In the illustrative case, the subject recruiter ranks in the 58^{th} percentile among comparable recruiters as identified by the recruiter search module 108 and as displayed in the recruiter population window 206, i.e., that approximately fifty-eight (58) percent of the one hundred eighty-three (183) identified comparable recruiters have a lower response rate statistic 208 than the subject recruiter.

The recruiter population window 206 displays factors 212 in a factors list 214 that are utilized in obtaining a comparable recruiter population, the number of which is displayed in the comparable recruiter population statistic 216, i.e., one hundred eighty-three (183). The factors 212 are accompanied by indicator boxes 218 that indicate which factors 212 are utilized in obtaining the comparable recruiter population. The indicator boxes 218 may be unchangeable for a user or may be pick boxes that allow for the factors 212 to be manually selected or deselected by a user. Based on the manual selections or deselections, the comparable recruiter population statistic 216 may be dynamically recomputed and updated by the recruiter search module 108. The change in the comparable recruiter population statistic 216 may then be utilized to dynamically re-compute and update the comparable recruiter ranking 210 based on the new comparable recruiter population.

The factors 212 in the example embodiment including the following specific factors: a recruiter role factor 212A related to a role the recruiter plays in the recruiter's own company, e.g., a junior recruiter, a senior recruiter, a manager, etc.; a recruiter contract/incentives factor 212B, e.g., how is the recruiter compensated or incented as part of their job; a recruiter employer size factor 212C, e.g., how many employees work at the recruiter's employer or the employer the recruiter is recruiting for; a recruiter industry factor 212D for the industry the recruiter's employer or the employer the recruiter is recruiting for, e.g., selected form a predetermined list of industries employers may be divided into; a candidate seniority factor 212E related to an amount of total experience or seniority a candidate has in their field or in their current position; a candidate job position factor 212F related to jobs the candidates the recruiter has recruited at the time the candidate was contacted by the recruiter, e.g., “software engineer”, “administrative assistant”, “manager”, etc.; a candidate employer size factor 212G relating to the number of employees the candidate's then-employer had at the time the candidate was contacted; and a candidate employer industry factor 212H related to an industry the candidate was working in at the time the candidate was contacted. It is noted that for candidates who were not currently employed at the time the candidate was contacted, properties of their previous employer may be considered instead of their current employer.

In various examples, a user may reorder the factors 212 on the factors list 214 to impact the order in which the factors are considered. Thus, for instance, if a user is particularly interested in the subject recruiter's effectiveness in comparison to other recruiters at comparable candidate seniority, job position, employer size, and employer industry, those factors 212E, 212F, 212G, 212H may be moved higher on the factors list 214 than other factors. The user interface 200 may allow for reordering by, e.g., a drag-and-drop function of the factors 212 themselves or any other suitable mechanism.

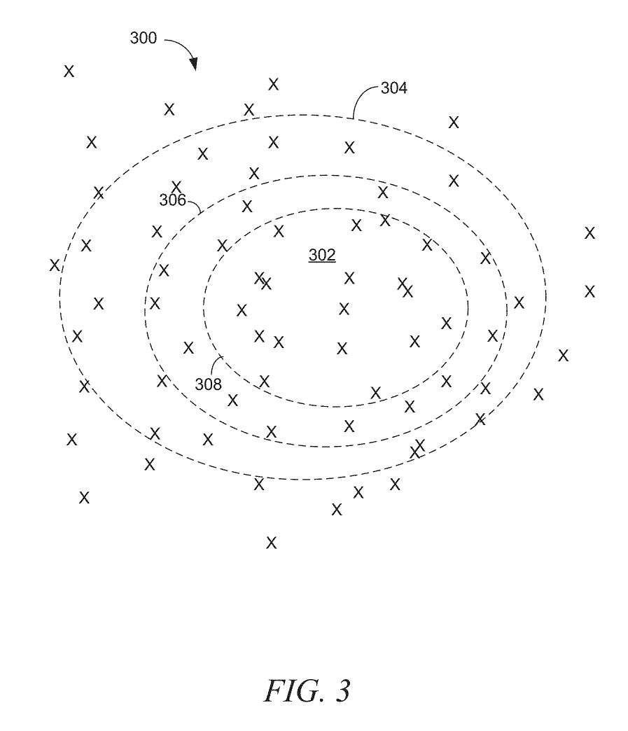

FIG. 3 is a simplified diagram of a recruiter population 300 as factors 212 are successively, individually applied from the factors list 214 to the population to obtain a comparable recruiter population 302, in an example embodiment. It is noted that the diagram is much smaller than the overall recruiter population 300 may typically be for illustrative purposes. Each X denotes a single recruiter having various data stored in the data layer 105. The subject recruiter similarly has the same data available in the data layer 105.

As illustrated, the diagram illustrates how factors 212 are successively applied from the factors list 214 to narrow from the recruiter population 300 down to the comparable recruiter population 302. Each boundary 304, 306, 308 corresponds to one of the factors 212. In the illustrated example, the first boundary 304 corresponds to the recruiter role factor 212A, the second boundary 306 corresponds to a recruiter contract factor 212B, and the third boundary 308 corresponds to the recruiter employer size factor 212C. In the interest of simplicity, only three boundaries 304, 306, 308 are illustrated, but it is to be recognized and understood that the number of boundaries that may be overlaid on the recruiter population 300 correspond to the number of factors 212 applied to obtain the desired comparable recruiter population 302.

As each boundary 304, 306, 308 is applied successively, the recruiter population 300 shrinks to those includes only those recruiters X still within all of the boundaries 304, 306, 308 that have then been applied. Thus, prior to the first boundary 304 the recruiter population 300 is an initial population of all of the recruiters X, after the first boundary 304 is applied the recruiter population 300 is the recruiters X within the first boundary, after the second boundary 306 is applied the recruiter population is the recruiters X within the second boundary 306, and so forth.

In the illustrated example, the recruiters X in the comparable recruiter population 302 are those who have the same or similar information from the data layer as the subject recruiter for each of those three factors 212. As illustrated, the factors 212 are successively applied from the factors 212 as listed in the recruiter population window 206 until the number of recruiters X within the last-applied boundary 308, i.e., the third boundary 308 corresponding to the recruiter employer size, is within a predetermined range. In the illustrated example, the number of recruiters X in the comparable recruiter population 302 is nineteen (19).

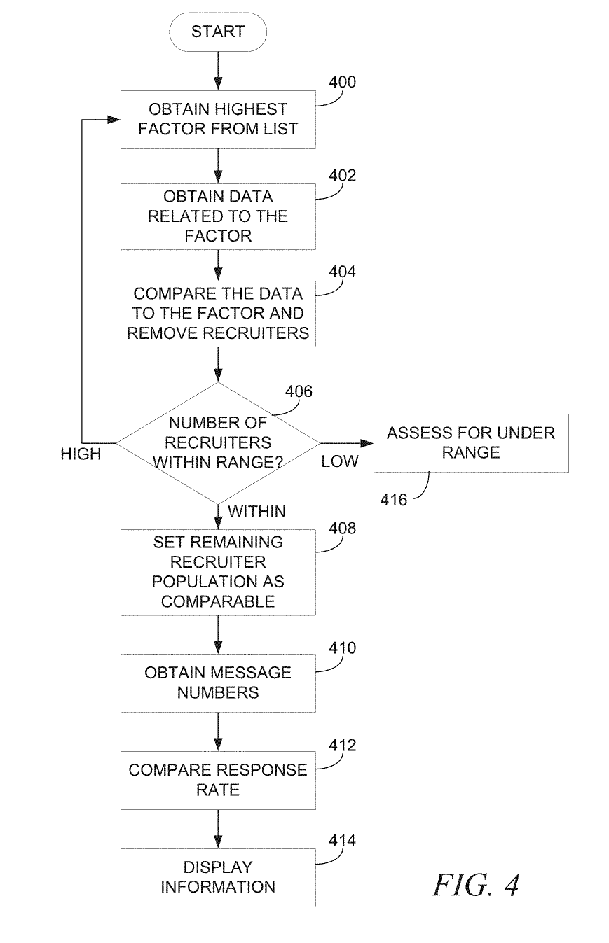

FIG. 4 is a flowchart for successively applying factors 212 to the recruiter population 300 to obtain the comparable recruiter population 302, in an example embodiment. The operations of the flowchart may be implemented by the recruiter search module 108, though it is noted and emphasized that the operations may be implemented by any suitable system.

At 400, the recruiter search module 108 obtains a highest factor 212 on the factor list 214 that has not yet been considered. In the first pass through the flowchart, the highest factor would be the recruiter role factor 212A. Once the recruiter role factor 212A has been implemented, the highest factor would be the recruiter contract factor 212B, and so forth.

At 402, the recruiter search module 108 obtains data from the data layer 108 pertaining to the factor 212 obtained at 400 for each recruiter X who has not yet been placed outside of a boundary 304, 306, 308 placed by application of a prior factor 212. Thus, for the recruiter role factor 212A, the recruiter search module 108 obtains for the subject recruiter their role, e.g., junior recruiter (e.g., zero to five years of experience), senior recruiter (e.g., more than five years of experience), or manager. For the recruiter contract/incentives factor 212B, the recruiter search module 108 obtains data on whether the recruiter is, e.g., salaried, incented, or hybrid. For the recruiter employer size factor 212C, the recruiter search module 108 obtains data on a number of recruiters employed by the recruiter's employer, e.g., fewer than ten (10) recruiters, ten (10) to one hundred (100) recruiters, and more than one hundred recruiters (100).

For the recruiter industry factor 212D, the industry/industries for which the recruiter has recruited may be compared against a predetermined list of industries, e.g., consumer electronics, enterprise software, home building, commercial building, home furnishings, legal services, etc. The industries may be decided as a single most common industry or may be any industry the recruiter has recruited for. For the candidate seniority factor 212E, the recruiter search module 108 obtain data on the number of years of experience of the candidates the recruiter has contacted. The number of years of experience may be an average of all of the candidates, another statistical consideration, or a range, e.g., two years to twenty-five years of experience. For the candidate job position factor 212F, the candidate job position may reflect a most common position held by candidates the recruiter has recruited, any position held by candidates the recruiter has recruited, a predetermined number of the most common positions the candidates have held, or any other combination or consideration of current candidate positions.

For the candidate employer size factor 212G, the number of employees by candidates' employers may be averaged or otherwise combined, a most common employer size may be used, or any other mechanism for obtaining a composite or representative employer size for a candidate may be used. The composite or representative employer size may be utilized in a range, e.g., less than one hundred employees, one hundred to one thousand employees, one thousand and one to ten thousand employees, or more than ten thousand employees. For the candidate employer industry factor 212H, the same principles applied to the recruiter industry factor 212D may be applied to the industries of the candidates recruited. As with the candidate job position factor 212F, the candidate employer industry factor 212H for a recruiter may be based on a most common candidate employer industry that the recruiter has recruited for, a predetermined number of the most common candidate employer industry, all of the candidate employer industries, or any other mechanism for narrowing down the candidate employer industries.

In various examples, where a single recruiter may recruit for a range of candidate types the recruiter may be assessed for an average candidate type, e.g., the average seniority of the recruiter's candidates for the candidate seniority factor 212E, or for a most common seniority of the recruiter's candidates. Additionally or alternatively, the user interface 200 may provide for a user to select which among multiple possible data points may be selected and implemented. Thus, a user may select that, when a subject recruiter has both senior and junior candidate seniority, that only senior candidates are to be considered.

It is further noted and emphasized that while example ranges are provided that the comparison may be made on the basis of percentage similarity, e.g., within twenty-five (25) percent of the subject recruiter's data. Thus, for instance, if the average candidate for the subject recruiter has a seniority of ten (10) years, a recruiter X from the recruiter population may be considered similar if their average seniority of their candidates is within twenty-five (25) percent of ten (10) years, i.e., from 6.5 years to 12.5 years.

At 404, the recruiter search engine 108 compares user data to the current factor 212 for the subject recruiter and the user data for the factor for the recruiters X in the recruiter population 300 that have not already been removed from the recruiter population 300 by previous factors 212. A recruiter X who matches the factor 212 under consideration with the subject recruiter remains in the recruiter population 300—in the diagram of FIG. 3, the recruiter X is within the boundary 306 corresponding to the factor 212—while a recruiter X who does not match the factor 212 is removed from the recruiter population 300—in the diagram of FIG. 3, the recruiter X is outside of the boundary 306 corresponding to the factor 212.

To illustrate the operation 404 with respect to FIG. 3, the recruiter role factor 212A is the factor under consideration, and the first boundary 304 corresponds to the recruiter role factor 212A. The subject recruiter, i.e., Jane Roe, is a junior recruiter. All of the recruiters X within the boundary 304 likewise have data from the data layer 105 that they are junior recruiters while all of the recruiters X outside of the boundary 304 are senior recruiters or managers.

To further illustrate the operation 404 with respect to FIG. 3, after the recruiter role factor 212A has been applied, the recruiter contract/incentives factor 212B is applied on a second iteration of the flowchart of FIG. 4 and illustrated as the boundary 306. In such an example, the subject recruiter is a salary recruiter. All of the recruiters X within both the boundaries 304, 306 are junior recruiters who are salaried, while the recruiters X within the boundary 304 but not within 306 are junior recruiters who have incentives or hybrid arrangements. The principles illustrated with respect to the factors 212A and 212B may be applied to successively factors to reduce the recruiter population 300.

At 406, the recruiter search module 108 assess the recruiters X who remain within the recruiter population 300, i.e., those recruiters X who are still within the boundary 304, 306, 308, corresponding to the most recently applied factor 212, to determine if the number of recruiters in the recruiter population 300 is within a predetermined range. In various examples, the predetermined range includes an upper bound and a lower bound. In an example, the upper bound is five hundred (500) and the lower bound is twenty (20). However, it is to be recognized that the range may be adapted to the size of the starting population. Thus, for a relatively large population the range may be moved higher. In the illustrated population of FIG. 3, the range may be between twenty (20) and twelve (12).

If the recruiter population 300 is within the predetermined range then the recruiter search module 108 proceeds to display the analytic data at operation 408. If the recruiter population 300 is higher than the predetermined range then the recruiter search module 108 returns to operation 400 to apply a subsequent factor 212. If the recruiter population 300 is lower than the predetermined range then the recruiter search engine 108 proceeds to operation 416.

At 408, the recruiter search engine 108 sets the remaining recruiter population 300 as the comparable recruiter population 302.

At 410, the search module 108 acquires, for the subject recruiter as well as the recruiters of the comparable recruiter population 302, a number of recruiting electronic messages the recruiter has send to candidates and a number of responses the candidates have sent back to the recruiter. The recruiter search engine 108 then obtains the response rate for the subject recruiter and each recruiter of the comparable recruiter population 302 by dividing the number of responses by the number of messages sent for each recruiter, respectively.

At 412, the recruiter search module 108 compares the response rate for the subject recruiter to the response rates of the comparable recruiter population 302 to determine what percentile the subject recruiter is among the comparable recruiter population 302.

At 414, the recruiter search module 108 displays the relevant information on the user interface 200. In various examples, the recruiter search module 108 also updates the comparable recruiter population statistic 216 as well as the indicator boxes 218 to show which factors 212 were actually applied to obtain the comparable recruiter population 302.

At 416, the recruiter search engine 108 may assess that the recruiter population 300 has fallen below the predetermined range and determine how that is to be resolved, though the resolution may be context-dependent. In an example, the recruiter search engine 108 may reorder the factors 212 and apply the factors 212 as reordered. If the factors 212 as reordered produce recruiter population 300 within the predetermined range then the factor list 214 may be reordered to reflect the order of the factors 212 as actually applied. If reordering does not work then the recruiter search engine 108 may display that a suitable comparable recruiter population 302 was not found and the comparable recruiter ranking 210 could not be determined. Any other suitable response may be generated as well.

It is noted and emphasized that the principles disclosed with respect to candidate response rate may be applied to any other desired statistic along with the candidate response rate. Thus, the recruiter search module 108 may also compute, e.g., a candidate hire rate utilizing the same principles, a rate at which electronic communications are sent out to candidates without respect to whether or not candidates respond, a variety of financial statistics, location statistic, and so forth. Thus, the recruiter search module 108 may compute and display multiple statistics for a subject recruiter.

It is further noted and emphasized that the operations described in the flowchart of FIG. 4 may be separated in time and/or divided between an offline system and an online system implemented by the recruiter search module 108. In various examples, the operations 400-408 may be performed offline, e.g., with background resources of the recruiter search module 108 and without respect to a particular inquiry. Rather, the recruiter search module 108 may, on an ongoing basis, identify and/or update for some or all of the recruiters the comparable recruiter population 302 for that recruiter. When an inquiry regarding how that recruiter compares to their comparable recruiters is received, e.g., via the user interface, may the operations 410-414 occur on the basis of the comparable recruiter population 302 that had previously been stored and without necessarily having to repeat the operations 400-408.

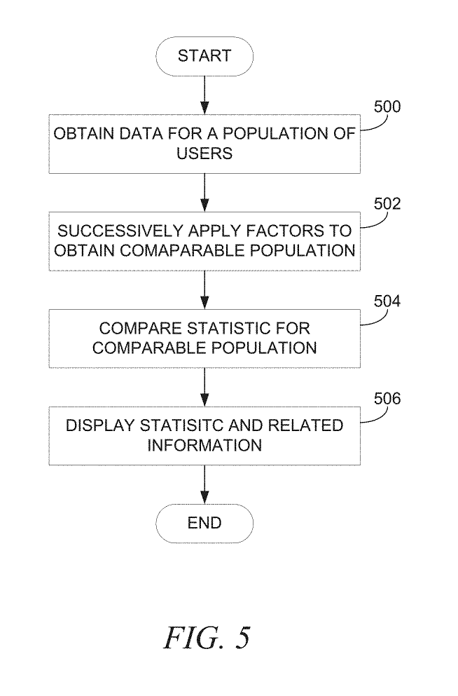

FIG. 5 is a flowchart for applying generating a user interface for comparable recruiter information, in an example embodiment. While the flowchart is described with respect to the online social networking system 100, it is to be recognized and understood that the operations of the flowchart may be performed by any suitable system.

At 500, for a population of users of an online social networking system having a common profession, data related to factors pertaining to the profession is obtained from a database of the online social networking system.

At 502, for each of the factors individually, those users whose data relating to the factor is not similar to related data of a subject user are successively removed from the population of users until a quantity of the population of users is within a predetermined range to obtain a comparable population of users that have similar data to the subject user. In an example, the predetermined range has an upper limit and a lower limit greater than one. In an example, the factors are applied according to a predetermined order.

In an example, the profession is a recruiter. In an example, the factors are related to a response rate to electronic messages send to members of the online social networking system by the subject user and the population of users. In an example, the factors include at least two of: a role of the user in their own organization; an incentive for the user; a size of an employer the user is recruiting for; an industry of the employer the recruiter is recruiting for; a seniority of a candidate member; a job position of the candidate member; an employer size of the candidate member; and an industry of the candidate member.

At 504, a statistic from the data of the subject user is compared against the same statistic from the data of each of the users of the comparable population of users to obtain a comparison. In an example, the comparison is a percentile rank of the statistic of the subject user relative to the statistics of the comparable population of users.

At 506, the user interface is caused to display the statistic and information related to the comparison.

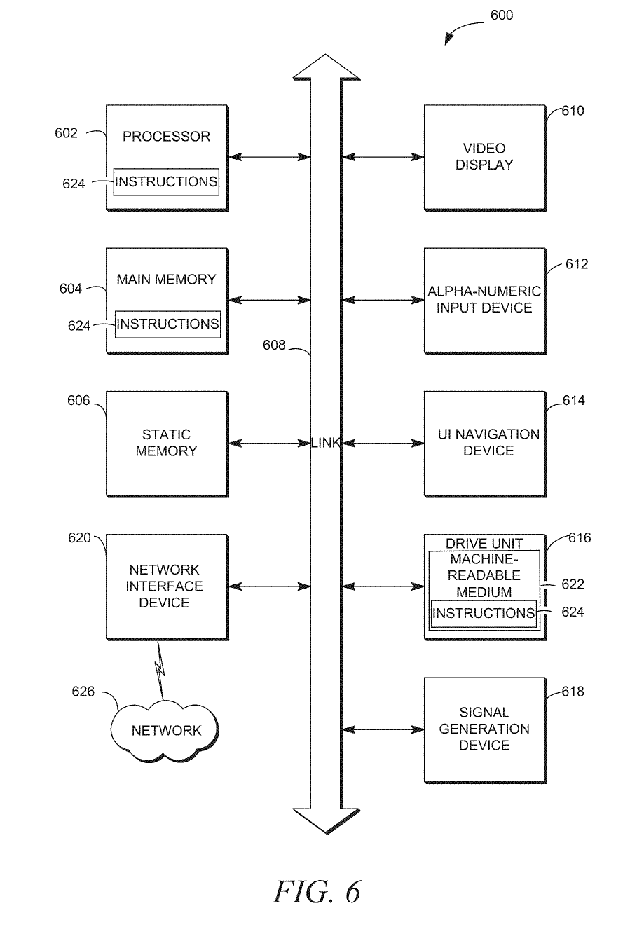

FIG. 6 is a block diagram illustrating components of a machine 600, according to some example examples, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system and within which instructions 624 (e.g., software) for causing the machine 600 to perform any one or more of the methodologies discussed herein may be executed. In alternative examples, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing or carrying instructions (e.g., software) for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium including a signal or a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A processor-implemented method, comprising:
obtaining, for a population of users of an online social networking system having a common profession, data related to factors pertaining to the profession from a database of the online social networking system;
successively, for each of the factors individually, removing from the population of users those whose data relating to the factor is not similar to related data of a subject user until a quantity of the population of users is within a predetermined range to obtain a comparable population of users that have similar data to the subject user;
comparing a statistic from the data of the subject user against the same statistic from the data of each of the users of the comparable population of users to obtain a comparison; and
causing a user interface to display the statistic and information related to the comparison.

2. The method of claim 1, wherein the predetermined range has an upper limit and a lower limit greater than one.

3. The method of claim 1, wherein the comparison is a percentile rank of the statistic of the subject user relative to the statistics of the comparable population of users.

4. The method of claim 1, wherein the profession is a recruiter.

5. The method of claim 4, wherein the factors are related to a response rate to electronic messages send to members of the online social networking system by the subject user and the population of users.

6. The method of claim 5, wherein the factors include at least two of: a role of the user in their own organization; an incentive for the user; a size of an employer the user is recruiting for; an industry of the employer the recruiter is recruiting for; a seniority of a candidate member; a job position of the candidate member; an employer size of the candidate member; and an industry of the candidate member.

7. The method of claim 1, wherein the factors are applied according to a predetermined order.

8. A computer readable medium comprising instructions which, when implemented by a processor, cause the processor to perform operations comprising:
obtain, for a population of users of an online social networking system having a common profession, data related to factors pertaining to the profession from a database of the online social networking system;
successively, for each of the factors individually, remove from the population of users those whose data relating to the factor is not similar to related data of a subject user until a quantity of the population of users is within a predetermined range to obtain a comparable population of users that have similar data to the subject user;
compare a statistic from the data of the subject user against the same statistic from the data of each of the users of the comparable population of users to obtain a comparison; and
cause a user interface to display the statistic and information related to the comparison.

9. The computer readable medium of claim 8, wherein the predetermined range has an upper limit and a lower limit greater than one.

10. The computer readable medium of claim 8, wherein the comparison is a percentile rank of the statistic of the subject user relative to the statistics of the comparable population of users.

11. The computer readable medium of claim 8, wherein the profession is a recruiter.

12. The computer readable medium of claim 11, wherein the factors are related to a response rate to electronic messages send to members of the online social networking system by the subject user and the population of users.

13. The computer readable medium of claim 12, wherein the factors include at least two of: a role of the user in their own organization; an incentive for the user; a size of an employer the user is recruiting for; an industry of the employer the recruiter is recruiting for; a seniority of a candidate member; a job position of the candidate member; an employer size of the candidate member; and an industry of the candidate member.

14. The computer readable medium of claim 8, wherein the factors are applied according to a predetermined order.

15. A system, comprising:
a computer readable medium comprising instructions which, when implemented by a processor, cause the processor to perform operations comprising:
obtain, for a population of users of an online social networking system having a common profession, data related to factors pertaining to the profession from a database of the online social networking system;
successively, for each of the factors individually, remove from the population of users those whose data relating to the factor is not similar to related data of a subject user until a quantity of the population of users is within a predetermined range to obtain a comparable population of users that have similar data to the subject user;
compare a statistic from the data of the subject user against the same statistic from the data of each of the users of the comparable population of users to obtain a comparison; and
cause a user interface to display the statistic and information related to the comparison.

16. The system of claim 15, wherein the predetermined range has an upper limit and a lower limit greater than one.

17. The system of claim 15, wherein the comparison is a percentile rank of the statistic of the subject user relative to the statistics of the comparable population of users.

18. The system of claim 15, wherein the profession is a recruiter.

19. The system of claim 18, wherein the factors are related to a response rate to electronic messages send to members of the online social networking system by the subject user and the population of users.

20. The system of claim 19, wherein the factors include at least two of: a role of the user in their own organization; an incentive for the user; a size of an employer the user is recruiting for; an industry of the employer the recruiter is recruiting for; a seniority of a candidate member; a job position of the candidate member; an employer size of the candidate member; and an industry of the candidate member.
